(19) United States
(12) Patent Application Publication
(10) Pub. No.: US 2008/0275792 A1
(43) Pub. Date: Nov. 6, 2008

(54) Web Based Marketing Method

(76) Inventor: Carl Wise, Sarasota, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 10/599,271

(22) PCT Filed: Mar. 23, 2005
(86) PCT No.: PCT/US05/09793

§ 371 Date: Jul. 22, 2008

Related U.S. Application Data
(60) Provisional application No. 60/555,743, filed on Mar. 23, 2004.

(51) Int. Cl. G06Q 30/00

(52) U.S. Cl. 705/27

(57) ABSTRACT

A web-based system and method of distributing products which are produced at a location remote from the seller. The system includes an administrator who creates a website having workrooms for each member of the organization. Each member of the system is a seller and producer of a product. Templates are provided in the workroom to permit the members to upload inventory and pricing information. Members will also be permitted to enter markup pricing for transactions where they are acting as sellers. A search engine permits sellers to search the inventory of producers by geographic and other protocol. The inventory along with pricing information which includes both the producer's cost and the seller's markup is displayed at the seller's terminal. The system also includes provisions for affiliates to purchase products form producers either for resale or on a volume discount.

### RELATED APPLICATION

This application claims priority of U.S. Provisional Patent Application Ser. No. 60/555,743 filed Mar. 23, 2004, which is incorporated herein by reference.

### BACKGROUND OF THE INVENTION

### Field of the Invention

Local and regional businesses have long relied on intermediaries such as ED or Teleflora in the floral business to provide products in remote locations.

The intermediary designs specific products which are provided by the florist. Pricing is set by the intermediary. This requires the florist to maintain a supply of materials which will meet the intermediary design. Accordingly, it would be desirable to provide a system which would permit local businesses to promote their own products and services through brick and mortar outlets in remote locations. Additionally, it would be desirable to provide a system which permitted the same merchants and service providers to develop a system of providing products through affiliates.

### SUMMARY OF THE INVENTION

The invention is directed to a web-based system and method of distributing products for members of an organization. The system permits sellers to sell product produced by members who are in remote locations. Members are businesses who act both as sellers and producers of the products. The system includes a website. The website includes separate workrooms for each member. Each workroom includes templates to permit members to upload inventory and producer pricing information for the inventory which is to be produced by the member. Members also enter selling information for transactions in which the member acts as a seller. All of the information is stored in a database. A search engine is provided to the sellers for searching and selecting a producer in the desired geographic location according to a protocol. The selected inventory is then delivered to the seller with pricing which includes both the producer's pricing and the seller's markup. Separate workrooms are established for affiliates who are only resellers or bulk purchasers of the products to permit affiliates to resell or purchase product from an associated member.

### BRIEF DESCRIPTION OF THE DRAWING

FIG. 1 is a block diagram of a system for distribution of product in accordance with the invention;

FIG. 2 is a block diagram of an administrator for the system in accordance with the invention;

FIG. 3 is a block diagram of a workroom in accordance with the method; and

FIG. 4 is a block diagram of the method in accordance with the invention.

### DETAILED DESCRIPTION OF THE INVENTION

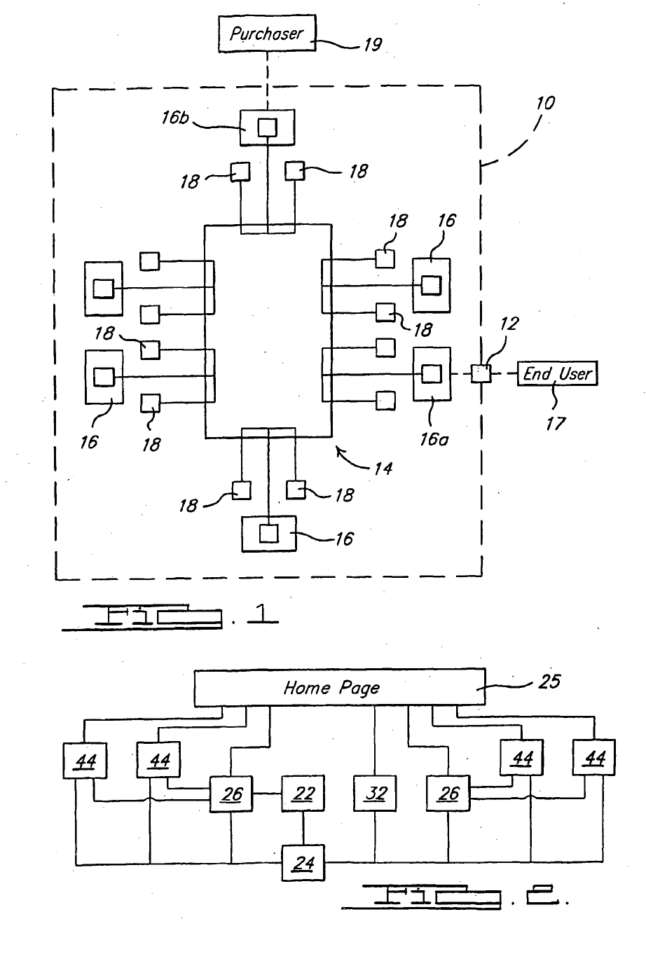

As shown in FIG. 1, the invention is directed to a system 10 of distributing products 12 through an electronic network which includes an administrator 14, members 16, and may include affiliates 18. The members 16 are businesses which both sell and produce the product 12. Affiliates 18 are enrolled by individual members 16 and either buy product in bulk or act as resellers. Product 12, as used herein, refers to either goods or services. The system is particularly for businesses which require a provider 16a of the product 12 to be located in close proximity to an end user 17 while the seller 16b is located in a remote location close to a purchaser 19. The preferred embodiment will be discussed with respect to the floral business, however the system 10 may be used in a wide variety of businesses.

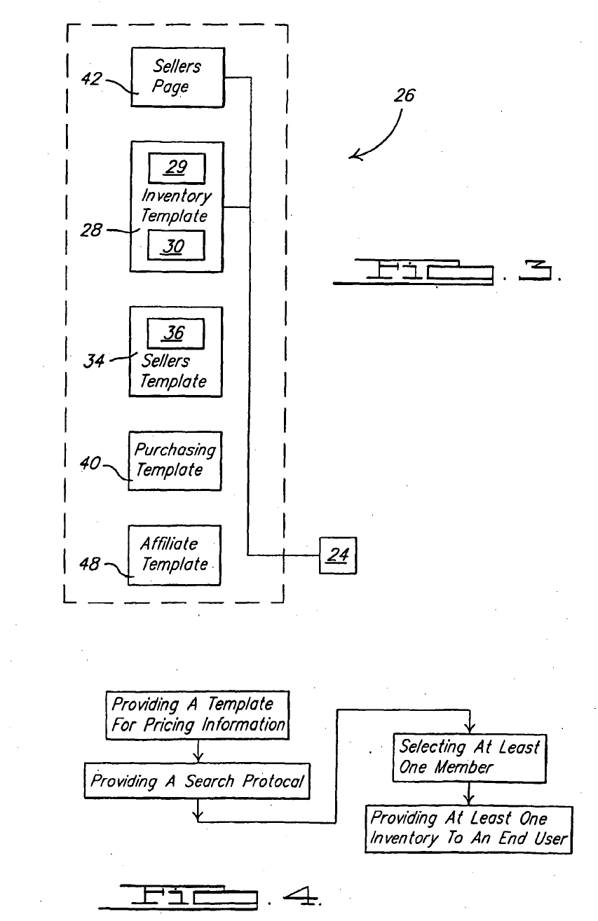

As shown in FIGS. 2 and 3, the administrator 14 provides an electronic communications network such as a website 20, a search engine 22, and a database 24. The website includes a home page 25 and a plurality of workrooms 26. Each member 16 is assigned a workroom 26. The workroom 26 is entered through the homepage displayed on a member's terminal. The member 16 is prompted to enter a user name and PIN. Only the administrator and assigned member is permitted access to the workroom 26. Each workroom 26 has an inventory template 28 for entering inventory information 30. Digital photographs and/or video of the product may be uploaded to the database through the inventory template 28. The inventory information 30 includes inventory description, product pricing 29, delivery and availability. The workroom 26 also has a seller's template 34 for entering seller information. The seller information is used when the member 16 is acting as a seller. The seller information includes a markup percentage 36. All of the information is stored in the database 24.

The administrator 14 creates a member profile 32 which is stored in the database 24 for each member. The member profile contains information about the member including identity and location of the member 16. The member information also includes a rating for the member 16 which is determined by the administrator 14. The rating provides indication to the other members as to a particular member's performance with respect to stated criteria. Thus, in the case of a florist, the criteria may be promptness of delivery, quality such as freshness of the flowers, customer complaints, etc. This permits the administrator 14 to assign a rating so that the other members have an indication of the value of the services provided by that member and the rating also provides the member with the ability to improve the rating by improving its performance in the stated criteria.

When a member is acting as the seller 16b, a seller's page 42 is selected from the menu on the home page 25. The member 16a is prompted to enter type of product and geographical region where the product 12 is to be delivered. The search engine 22 selects the provider member 16a from a region by searching the database 24 according to a protocol established by the administrator 14 and seller's requirements and displays the identity and location of eligible producers. The inventory is displayed on a seller's page having a window for displaying information about the inventory from the inventory information. The digital photo or video may be viewed as well. The seller's page also contains the identity of the seller 16b, so that the inventory will appear to a customer as being that of the seller. Pricing information will also be displayed. The price is calculated using the inventory price 29 established by the producer together with the markup percentage 36 entered by the seller member from the seller template 34.

As shown in FIG. 3, if the purchaser wishes to buy, the seller selects a page having a purchasing template 40 for placing an order including credit card information. The order is sent to the administrator who places the charge and electronically places the order by sending an electronic communication to the producer and then sends a confirmation to the seller member. The administrator collects the price of the sale from the credit card company, and credits the accounts of the seller and producer less a service charge.

As shown in FIGS. 1 and 2, each member 16 may establish one or more affiliates 18.

Affiliates 18 may be either direct affiliates or reseller affiliates. Direct affiliates are major customers of the member who are entitled to a volume discount. Thus, in the case of a florist, direct affiliates may be car dealerships, hospitals or hotels who regularly purchase products and are entitled to a discount. Reseller affiliates are affiliates who resell products to end users. In the case of a floral shop, reseller affiliates are typically funeral homes, hotels and restaurants who sell flowers directly to one of their customers. Affiliate pages 44 are accessible through the home page Access to the affiliate pages is restricted to the respective affiliate, and the member sets the pricing markup 36 for each direct affiliate using a direct affiliate template 48. The direct affiliate thus has the ability to enter a florist webpage website, sign on as a direct affiliate member, view the inventory offered by the associate member, place an order, and have the product delivered for the discounted price determined for that affiliate.

If the affiliate 18 is a reseller affiliate, inventory is loaded onto pages created for the reseller affiliate from the associate member inventory. The name of the reseller affiliate may be provided on the page. The provider member 16a always receives the price set on the goods; however, the reseller affiliate is free to sell it at whatever price it wishes. Thus, reseller affiliates such as a funeral home or hotel may offer the goods such as flowers directly to a client at the time of making funeral arrangements. The funeral director may go to the appropriate webpage, display the inventory, and show the prices. The reseller may also place orders directly through the page by clicking on a button. The order is transmitted to the member through the administrator and the affiliate is billed in accordance with prearranged payment policy.

The webpages are produced by a vendor selected by the administrator. The member or affiliates can contract with the vendor to integrate the system pages with the preexisting website through that vendor. These services as well as other system services are available to the vendors at discounted rates.

As shown in FIG. 4, the method includes the steps of providing a template for entering pricing inventory and inventory of products for a plurality of purchasers into a database, entering seller information including seller's markup into the database, providing a search protocol into a database, searching the database utilizing the protocol and selecting at least one producer's inventory from the inventories in the database displaying the at least one inventory along with a final price including the producer's price and seller's markup.

Thus is disclosed a system and method of conducting business which permits members of the organization to order products from other members for their customers and to determine the prices. Additionally, the system provides a method of providing the inventory to affiliates who may order for themselves at a discount or resell the goods at a price set by the reseller. It will be apparent to those skilled in the art that many variations may be had without departing from the spirit of the invention.

1. A method of providing products to users from sellers by way of a computer network, the method comprising the steps of:
providing a template for entering pricing information and an inventory of products by a plurality of producers into a database;
providing a template for entering a protocol into the database;
selecting at least one inventory from said plurality of inventory of products according to a protocol with a search engine; and
providing the at least one inventory with end user pricing information to the seller.

2. The method of claim 1 further comprising the step of calculating the price for the at least one inventory using the producer's pricing information.

3. The method of claim 2 wherein the calculating step further includes using the seller's markup to calculate the price.

4. The method of claim 2 wherein the calculating step includes using a markup for the seller which is provided by the producer.

5. The method of claim 1 wherein a plurality of workrooms are provided on a website for receiving the inventory and pricing information of a respective one of the plurality of producers.

6. A system for electronically providing products to users of the products through the system comprising:
a database having pluralities of inventories of products, each inventory uploaded into the database by a respective one of a plurality of producers;
a search engine having a protocol for selecting at least one inventory from the plurality of inventories according to a protocol provided to the search engine;
a template for displaying said at least one inventory of product selected by the search on a seller's terminal; and
a logic program for calculating a price for each product displayed on the seller's terminal, the logic program using pricing information supplied by the respective one of the plurality of producers and the seller's pricing information.

7. The system of claim 6 further comprising a template for electronically uploading the inventory of products into the database.

8. The system of claim 6 wherein the search further comprises a rating of producers supplied by the administrator, said rating being displayed on the seller's terminal with the pricing information.
